(19) United States
(12) Patent Application Publication
(10) Pub. No.: US 2026/0169686 A1
(43) Pub. Date: Jun. 18, 2026

(54) SIMILARITY-BASED TRANSFERRING TECHNIQUES FOR MACHINE LEARNED MODEL OUTPUTS

(71) Applicant: Optum Services (Ireland) Limited, Dublin (IE)

(72) Inventors: Breanndán O Conchuir, Kerry (IE); James McNair Sloan, Bathgate (GB); Matthew Robinson, Greystones (GB); Saurabh Goel, Naas (IE)

(21) Appl. No.: 18/980,567

(22) Filed: Dec. 13, 2024

(51) Int. Cl. G06F 5/01; G06F 17/16

(52) U.S. Cl. CPC G06F 5/01; G06F 17/16

(57) ABSTRACT

Various embodiments of the present disclosure provide a similarity-based output transferring technique that improves the functionality of a computer in various aspects. The techniques comprise receiving a feature vector for a target data object of a set of data objects, generating a feature matrix for the set of data objects based on the feature vector; generating a similarity matrix for the target data object based on the feature matrix; generating a set of model coefficients by normalizing the similarity matrix based on a normalization threshold; generating a transferred prediction for the target data object by applying the set of model coefficients to a set of causal predictions that respectively correspond to the set of data objects; and initiating a performance of a prediction-based action based on the transferred prediction.

### CROSS REFERENCE TO RELATED APPLICATIONS

This application is related to application Ser. No. 18/980,308, entitled Connected Model Framework for Forecasting Causal Predictions, filed Dec. 13, 2024, the content of which is incorporated herein for all purposes

### BACKGROUND

In various domains, supervised machine learning may be configured to model complex environments and make inferences based on learned relationships from labeled training data. Some traditional machine learning model may be configured for time-series predictions by encoding historical sequences of data as feature sequences that may used to train the model. However, the performance (e.g., in terms of accuracy) of such models is dependent on an availability (and/or length of) historical sequences of data sufficient to inform further predictions. Thus, while capable of making time-series predictions, the application of traditional graph-based machine learning models is limited to inferences with observable historical trends.

### BRIEF DESCRIPTION OF THE DRAWINGS

FIG. 1 depicts a block diagram of an example architecture in accordance with some embodiments of the present disclosure.

FIG. 2 depicts a block diagram of an example predictive data analysis computing entity in accordance with some embodiments of the present disclosure.

FIG. 3 depicts a block diagram of an example client computing entity in accordance with some embodiments of the present disclosure.

FIG. 4 depicts a dataflow diagram of a similarity-based output transferring technique in accordance with some embodiments of the present disclosure.

FIG. 5 is an operational example of an example feature matrix in accordance with some embodiments of the present disclosure.

FIG. 6 depicts a dataflow diagram of an example output model instantiation technique in accordance with some embodiments of the present disclosure.

FIG. 7 is a flowchart diagram of an example output transferring process in accordance with some embodiments of the present disclosure.

### DETAILED DESCRIPTION

Various embodiments of the present disclosure provide a connected model framework that improves a computer's functionality with respect to various inference tasks by uniquely coupling two, traditionally distinct model architectures into a single forecasting unit. To do so, some embodiments of the present disclosure provide a coupling mechanism that provides a feedback loop between a graph-based machine learning model and a series of causal models (e.g., causal DAGs). For example, the coupling mechanism may couple an input feature within the nodes of the graph machine learning model with an intermediate node of the causal model. By doing so, the coupling mechanism may create a continuous feed forward design in which a graph machine learning model may forecast unknown parameters for a series of causal models, while the causal models integrate different sets of known correlations to implement optional future scenarios. In this way, the connected model framework of the present disclosure provides an improved modeling framework that simultaneously addresses technical challenges with both traditional graph machine learning models and traditional causal modeling approaches to allow for improved inference capabilities. This, in turn, may enable new inferences that address optional scenarios traditionally outside the scope of machine learning.

In some embodiments of the present disclosure, a similarity-based output transferring approach is provided to extend the predictive capabilities of the connected model framework, and/or any other predictive model, to target data objects without requiring historical data for the target data objects. To do so, the similarity-based output transferring approach may define a set of feature comparison matrices, such as a feature matrix and/or a similarity matrix, that may model feature-level comparisons between a target data object and a set of reference data objects. Through a series of operations, the similarity-based output transferring approach may transform the set of feature comparison matrices into a set of model coefficients that define a relative feature-level similarity between the target and reference data objects. At inference, the set of model coefficients may be applied to predictive outputs for up to each of the set of reference data objects to transform predictive outputs for the reference data objects to a predictive output for the target data object. In this manner, the similarity-based output transferring approach of the present disclosure may enable the generation of an output transferring model that may compensate for technical challenges with traditional machine learning techniques, such as a lack of training data. This, in turn, expands the capabilities of predictive models to classifications, such as newly emergent phenomena, that lack sufficient historical data for training and/or configuring a traditional predictive model specialized to the classification.

Examples of technologically advantageous embodiments of the present disclosure comprise improved machine learning approaches that generate an output transferring model capable of transferring machine learning outputs for known phenomena to use cases with unknown phenomena that are traditionally outside the scope of machine learning frameworks, among other aspects of the present disclosure. Other technical improvements and advantages may be realized by one of ordinary skill in the art.

### I. OVERVIEW OF EMBODIMENTS

As should be appreciated, various embodiments of the present disclosure may be implemented as methods, apparatus, systems, computing devices, computing entities, computer program products, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. EXAMPLE FRAMEWORK

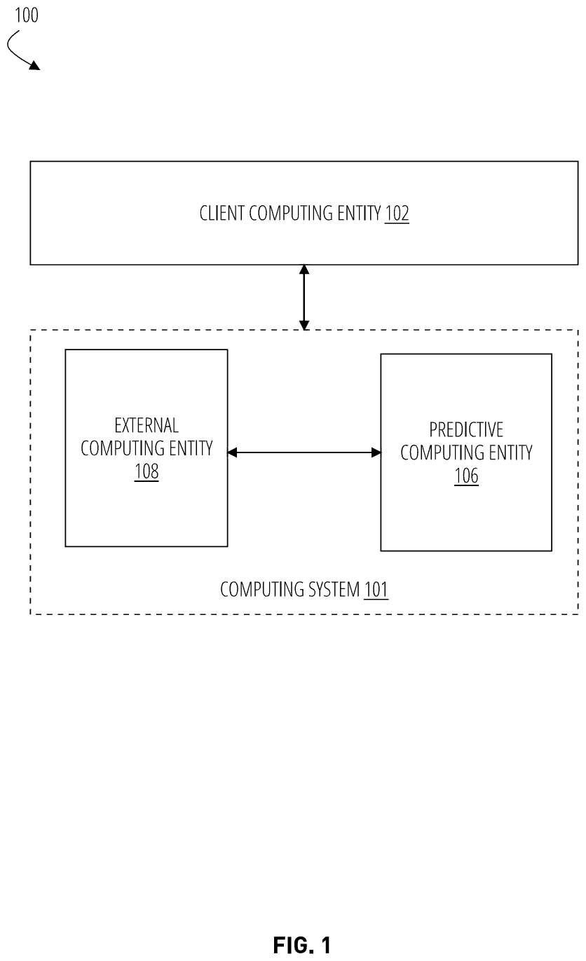

FIG. 1 depicts a block diagram of an example architecture 100 in accordance with some embodiments of the present disclosure. The architecture 100 comprises a computing system 101 configured to receive a feature vector for a target data object from client computing entities 102, process the feature vector, and provide the control instructions to the client computing entities 102. The example architecture 100 may be used in a plurality of domains and not limited to any specific application as disclosed herewith. The plurality of domains may comprise healthcare, industrial, manufacturing, computer security, and/or the like to name a few.

In accordance with various embodiments of the present disclosure, one or more machine learned models may be trained to generate candidate outputs, candidate output scores, and/or other machine learned outputs. The models may be adapted to generate sets of causal predictions, respectively corresponding to a set of mitigating actions, for a plurality of data objects. Some techniques of the present disclosure may adapt traditional models to a cohesive framework, such as a modular model ensemble, for more efficiently generating the causal predictions based on historical sequences associated with known data objects.

In some embodiments, the computing system 101 may communicate with at least one of the client computing entities 102 using one or more communication networks. Examples of communication networks comprise any wired or wireless communication network comprising, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may comprise a predictive computing entity 106 and one or more external computing entities 108. The predictive computing entity 106 and/or one or more external computing entities 108 may be individually and/or collectively configured to receive requests from client computing entities 102, process the requests to generate a code predictions, and provide the code predictions to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data processing and/or training tasks. The storage subsystem may comprise one or more storage units, such as multiple distributed storage units that are connected through a computer network. A storage unit in the respective computing entities may store at least one of one or more data assets and/or a set of data about the computed properties of one or more data assets. Moreover, each storage unit in the storage systems may comprise one or more non-volatile storage or volatile storage media similar to or different than the non-volatile and/or volatile computer-readable storage media discussed above.

In some embodiments, the predictive computing entity 106 and/or one or more external computing entities 108 are communicatively coupled using one or more wired and/or wireless communication techniques. The respective computing entities may be configured according to the techniques described herein to perform one or more operations of one or more techniques described herein. By way of example, the predictive computing entity 106 may be configured to train, implement, use (e.g., execute an inference operation(s)), update (e.g., fine-tune), and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., transferred prediction generation) described herein. The external computing entities 108, for example, may comprise and/or be associated with one or more entities that may be configured to receive, transmit, store, manage, and/or facilitate datasets, and/or the like. The external computing entities 108, for example, may comprise data sources that may provide such datasets, and/or the like to the predictive computing entity 106 which may leverage the datasets, such as data object feature vectors, historical sequences, etc., to perform one or more steps/operations of the present disclosure, as described herein. In some examples, the datasets may comprise an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for an information domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference steps/operations of the present disclosure. In some examples, feedback (e.g., evaluation data, ground truth data) from the use of the machine learning model may be received and/or stored by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Computing Entity

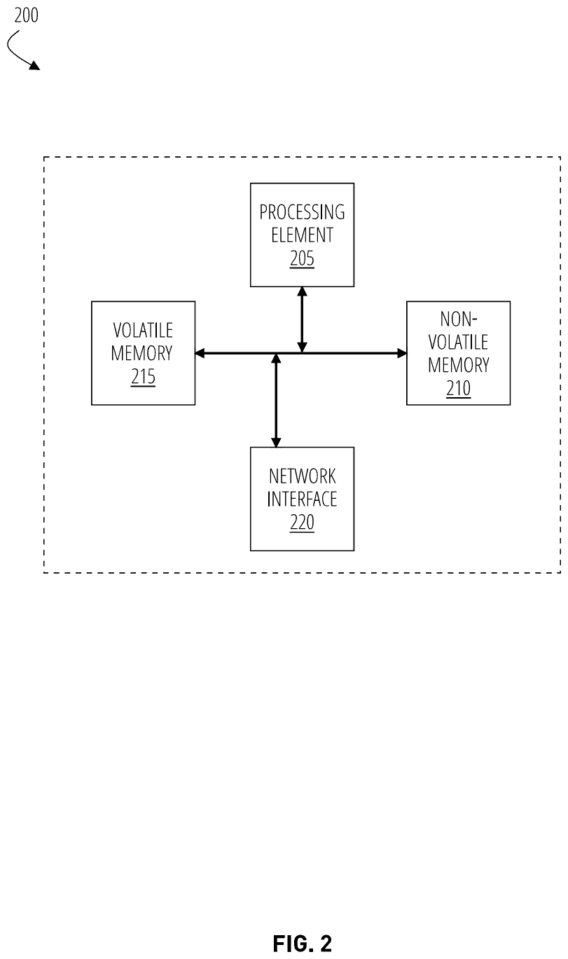

FIG. 2 depicts a block diagram of an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may comprise, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106) may train and use one or more machine learning models described herein. In other embodiments, a first computing entity (e.g., predictive computing entity 106, which may be one or more predictive computing entities) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets) to the first computing entity over a network.

As shown in FIG. 2, in some embodiments, the computing entity 200 may comprise, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, arithmetic logic units (ALUs) (e.g., which may be part of one or more graphics processing units (GPUs), tensor processing units (TPUs), and/or the like), coprocessing entities, application-specific instruction-set processors (ASIPs), microcontrollers, and/or controllers. Additionally, or alternatively, the processing element 205 may be embodied as one or more other processing devices and/or circuitry. The term circuitry may refer to an entirely hardware embodiment or a combination of hardware and computer program products. Examples of a combination of hardware and computer program products comprise application specific integrated circuits (ASICs), field programmable gate arrays (FPGAs), programmable quantum gate arrays, programmable logic arrays (PLAs), hardware accelerators, other circuitry, and/or the like. With respect to quantum computing embodiments of the computing entity 200, the processing element 205 may comprise specialized components for manipulating and measuring quantum states. These components may comprise quantum gates that perform operations on one or more qubits, quantum circuits that combine multiple gates to implement algorithms, measurement devices that extract classical information from quantum state, and/or the like. The quantum gates, circuits, and/or the like may be controlled, using one or more error correction mechanisms to compensate for decoherence and other quantum noise effects, to maintain quantum coherence while performing computations.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further comprise, or be in communication with, non-transitory computer readable media, such as non-volatile memory 210 (also referred to as non-volatile media, storage, memory storage, memory circuitry, and/or similar terms used herein interchangeably), volatile memory 215 (also referred to as volatile media, storage, memory storage, memory circuitry, and/or similar terms used herein interchangeably), quantum memory (e.g., solid quantum memory, atomic gas quantum memory), and/or the like.

In some embodiments, non-volatile memory 210 may comprise a computer-readable storage medium may comprise a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also comprise a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also comprise read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also comprise conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, volatile memory 215 may comprise a computer-readable storage medium comprising random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (comprising various levels), flash memory, register memory, and/or the like. It will be appreciated that where embodiments are described to use a computer-readable storage medium, other types of computer-readable storage media may be substituted for or used in addition to the computer-readable storage media described above.

In some embodiments, quantum memory comprises a memory structure that utilize quantum bits, or qubits, which may exist in multiple states simultaneously through a property called superposition. Unlike classical bits that may only be in a state of 0 or 1, qubits may represent both states at once, allowing for exponentially larger information storage capacity. These quantum memory structures must maintain quantum coherence, which refers to the delicate quantum mechanical state of the system, while also allowing for rapid access and manipulation of stored quantum information.

As will be recognized, the non-volatile memory 210, the volatile memory 215, and/or the quantum memory may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 205. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 by operating the processing element 205 according to software component(s) retrieved from any of the computer-readable storage media and executed by the processing element 205.

Embodiments of the present disclosure may be implemented in various ways, comprising as computer program products that comprise articles of manufacture. Such computer program products may comprise one or more software components comprising, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages comprise, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may comprise a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (e.g., executable instructions, instructions for execution, computer program products, program code, and/or similar terms used herein interchangeably). Such non-transitory computer-readable storage media comprise all computer-readable storage media (comprising volatile memory 215 and non-volatile memory 210). In some embodiments, the computer program product may be executed by the computing entity 200 and/or the client computing entity. For example, at least a first portion of the computer program product may be stored within the volatile memory 215 and/or non-volatile 210 of the computing entity 200. In addition, or alternatively, at least a second portion of the computer program product may be stored within the volatile and/or non-volatile memory of a client computing entity.

In some embodiments, one or more embodiments of the present disclosure may be implemented using general and/or specialized quantum computers. For example, the computing entity 200 may comprise quantum memory and/or quantum processing elements, as described herein, that may be configured for general processing and/or specialized processing tasks. In some examples, the quantum memory and/or quantum processing elements of the computer entity 200 may be specialized for machine learning task. By way of example, large language models (LLMs) and other transformer networks may be specially designed for operation within a quantum environment by replacing weight matrices in self-attention and/or multi-layer perceptron layers of such models with one or more combinations of two variational quantum circuits and/or a quantum-inspired tensor networks, such as a matrix product operator (MPO). In this way, LLM functionality may be enabled within a quantum environment by decomposing weight matrices through the application of tensor network disentanglers and MPOs. Similarly, quantum support vector machines, quantum neural networks, and/or any other machine learning architecture may be modified to a quantum environment for implementation by the computing entity 200. Thus, the machine learning architectures of the present disclosure may be configured for classical computer or quantum computers based on the embodiment.

As indicated, in some embodiments, the computing entity 200 may also comprise one or more network interfaces 220 for communicating with various computing entities (e.g., the client computing entity 102, external computing entities), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, IEEE 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may additionally or alternatively comprise, or be in communication with, one or more input elements/devices, such as input sensor(s). In some examples, the input sensor(s) may comprise one or more keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like. The computing entity 200 may additionally or alternatively comprise, or be in communication with, one or more output elements/devices (not shown), such as one or more speakers, visual display devices, haptic feedback devices, motion devices (e.g., electromechanically actuated devices), and/or the like.

### B. Example Client Computing Entity

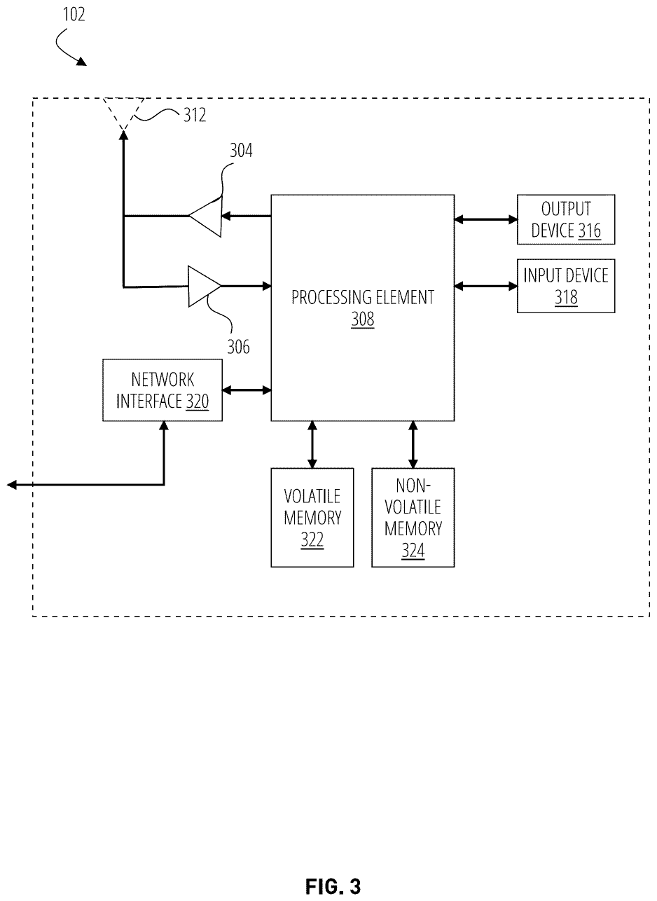

FIG. 3 depicts a block diagram of an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may comprise an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may comprise signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with one or more wireless and/or wired communication standards and protocols, such as those described above with regard to the computing entity 200.

The client computing entity 102 may additionally or alternatively download code, changes, add-ons, and updates, for instance, to its firmware, software (e.g., comprising executable instructions, applications, program modules), and operating system.

According to some embodiments, the client computing entity 102 may comprise location determining aspects, devices, modules, functionalities, and/or similar words used herein interchangeably. For example, the client computing entity 102 may comprise outdoor positioning aspects, such as a location component adapted to acquire, for example, latitude, longitude, altitude, geocode, course, direction, heading, speed, universal time (UTC), date, and/or various other information/data. In some embodiments, the location component may acquire data, sometimes known as ephemeris data, by identifying the number of satellites in view and the relative positions of those satellites (e.g., using global positioning systems (GPS)). The satellites may be a variety of different satellites, comprising Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, comprising cellular towers, Wi-Fi access points, and/or the like. Similarly, the client computing entity 102 may comprise indoor positioning aspects, such as a location component adapted to acquire, for example, latitude, longitude, altitude, geocode, course, direction, heading, speed, time, date, and/or various other information/data. Some of the indoor systems may use various position or location technologies comprising RFID tags, indoor beacons or transmitters, Wi-Fi access points, cellular towers, nearby computing devices (e.g., smartphones, laptops), and/or the like. For instance, such technologies may comprise the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface that may comprise an output device 316 coupled to a processing element 308 and/or a user input device 318 coupled to the processing element 308. An output device 316, for example, may comprise a hardware computing device comprising one or more output elements (not shown), such as one or more speakers, visual display devices, haptic feedback devices, motion devices (e.g., electromechanically actuated devices), and/or the like. A user input device 318 may comprise the same or different hardware computing device comprising one or more input elements (not shown), such as keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like.

In some examples, the user interface may additionally or alternatively comprise software component(s) executed by the processing element 308 to present (e.g., audibly, visually, tactilely) via a user input device 318 and/or output device 316 and/or a software endpoint such as an application programming interface (API) or exposed software function a graphical user interface (GUI) (e.g., at least a portion of a user application, browser), command-line interface, touch and/or haptic user interface, gesture and/or image capture-based interface, voice/audio user interface, and/or the like used herein interchangeably executing on and/or accessible via the client computing entity 102 to interact with and/or cause display of information/data from the computing entity 200, as described herein. In addition to providing input, the user input interface may be used, for example, to activate, deactivate, and/or modify certain functions, such as altering a power or operating state of the client computing entity 102, the computing system 101, the predictive computing entity 106, and/or the external computing entity 108.

The client computing entity 102 may further comprise, or be in communication with, one or more memory components, such as the volatile memory 322 and/or non-volatile memory 324. For example, the memory components may comprise non-transitory computer readable media, such as non-volatile memory 324 (also referred to as non-volatile storage, memory, memory storage, memory circuitry, and/or similar terms used herein interchangeably) and/or volatile memory 322 (also referred to as volatile storage, memory, memory storage, memory circuitry, and/or similar terms used herein interchangeably), as discussed above with reference to FIG. 2.

As will be recognized, the non-volatile memory 324 and/or the volatile memory 322 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 308. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In another embodiment, the client computing entity 102 may comprise one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity (e.g., an intelligent agent machine-learned model), such as AutoGPT, Mycroft, Rhasspy, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage component, and/or accessible over a network. In various embodiments, the AI computing entity may be configured to retrieve and/or execute one or more of the predefined program algorithms upon the occurrence of a predefined trigger event.

### III. EXAMPLE SYSTEM OPERATIONS

As indicated, various embodiments of the present disclosure make important technical contributions to applying machine learning approaches to use cases with unknown phenomena that are traditionally outside the scope of machine learning frameworks. In particular, systems and methods are disclosed herein that implement machine learning techniques on known phenomena and an output transferring model capable of transferring the machine learning output to unknown phenomena. By doing so, the techniques of the present disclosure enable the vast field of machine learning to be applied to unknown phenomena, decreasing ramp up times associated with classification and prediction for new and/or sparse data sets. This, in turn, may improve the functionality of a computer with respect to various computing tasks, comprising network security, machine learning training, and the like.

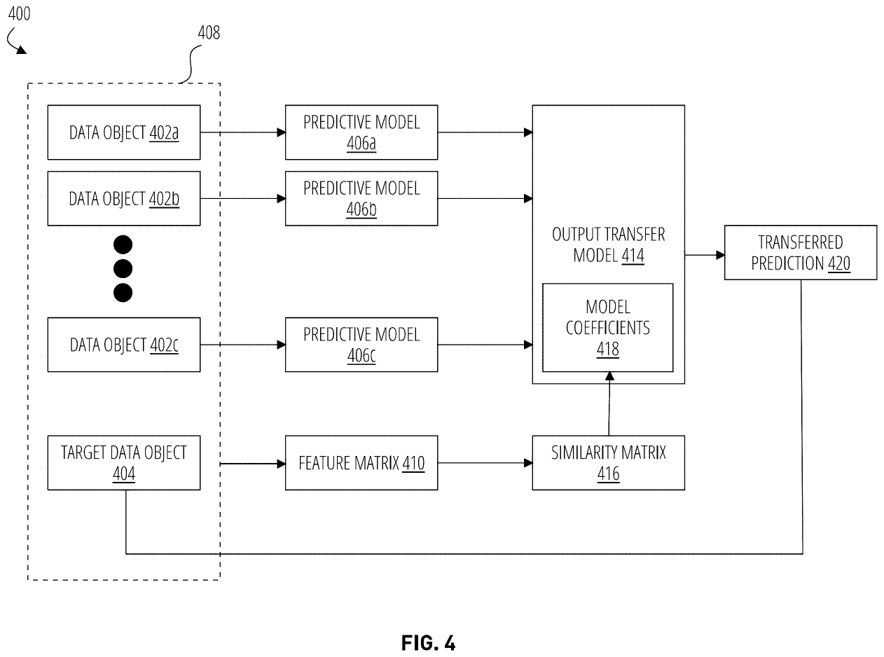

FIG. 4 depicts a dataflow diagram 400 of a similarity-based output transferring technique in accordance with some embodiments of the present disclosure. As depicted, the similarity-based output transferring technique derives a machine learned transferred prediction 420 for a target data object 404 using a set of data objects 408 as stand-ins for the target data object 404 within various predictive models 406a-c. For example, using collaborative filtering approaches, the set of data objects 408 may be compared to the target data object 404 to generate a set of derivative matrices that reflect a feature-level similarity between the target data object 404 and/or up to each of the set of data objects 408. By doing so, a computing system, such as the computing system 101, may derive a set of model coefficients 418 to initialize an output transfer model 414 for the target data object 404. The computing system 101 may apply the initialized output transfer model 414 to transform a set of machine learned outputs, generated by a set of different predictive models 406a-c with respect to their corresponding data objects 402a-c, into a transferred prediction 420 for the target data object 404. In this manner, the computing system 101 may overcome challenges with machine learning, such as a lack of training data, to adapt machine learning technology to target data objects 404 previously outside the scope of such technology.

In some embodiments, the computing system 101 receives a feature vector for a target data object 404 of a set of data objects 408. The set of data objects 408, for example, may comprise the target data object 404 and/or a subset of reference data object 402a-c. In some examples, the computing system 101 may receive a set of feature vectors that comprises a feature vector for up to each of the set of data objects 408.

In some embodiments, a reference data object 408 comprises a data structure associated with a target variable. A data object (e.g., set of data objects 408) may store, associate, and/or otherwise identify characteristics of a target variable. In some examples, a set of the characteristics may be represented as features within a feature vector corresponding to the data object. In some embodiments, the data entity is associated with a networked environment in which the characteristics of the data object depend on various interconnection properties. In some examples, the data object is associated with a historical sequence of time-varying elements that record changes in the target variable associated with the data object over time. For data objects with sufficient historical sequences (e.g., reference data objects 402a-c) the historical sequence of time-varying elements may be leveraged to configure and/or train a predictive model 406a-c to generate a prediction (e.g., a causal output and/or component thereof) of a future state (e.g., a time-varying element at a future time point) of the target variable. In some examples, mitigating actions may be designed to change an anticipated future state of the target variable. To account for these changes, a predictive model 406a-c may be constructed for the data object that comprises a machine learning model, such as a graph neural network, and/or one or more connected causal models respectively corresponding to one or more mitigation actions. By way of example, one such predictive model 406a-c may comprise a connected model framework as described in U.S. patent application Ser. No. 18/980,308, which is incorporated by reference herein for all purposes.

A data object and/or the one or more characteristics thereof may be configured for a specific domain to forecast a future state of a domain-specific target variable. For example, in a network security domain, a target variable may comprise one of a set of monitored computer virus, bugs, and/or the like. As another example, in a clinical use case, a target variable may comprise one of a set of diseases, mental health issues (e.g., cohorts of patients may be grouped based on a set of common conditions and tailored mitigating actions may be applied), and/or the like. In any use case, a historical sequence of time-varying elements may identify a historical number of occurrences (e.g., a severity) of the target variable within a networked location and a future state of the target variable may identify a forecasted number of occurrences of the target variable within the networked location. In some examples, a historical sequence of time-varying elements may be received for up to each of a set of networked locations to forecast a future state of the target variable based on the historical sequence of time-varying elements within the networked location and up to each of a set of networked locations connected to the network location. As such, when available, the historical sequences associated with a data object may be used to create complex predictive models 406a-c that are configured and/or trained to model nuanced interconnectivity attributes within a connected networked environment.

In some example, a set of data objects may be defined to track, monitor, and/or evaluate a set of different target variables within the networked environment. Up to each of the set of data objects, for example, may comprise a respective feature vector that defines one or more characteristics of one of the set of target variables. By way of example, in a network security domain, the set of data objects may respectively correspond to a set of different computer viruses, and/or the like. As another example, in a clinical domain, the set of data objects may respectively correspond to a set of different infectious diseases, mental health issues, and/or the like. In some examples, the predictive capability (e.g., in terms of accuracy, reliability) of a set of predictive models 406a-c respectively designed for the set of data objects may depend on the historical information (e.g., historical sequences) associated with the data object. In some examples, a set of reference data objects 402a-c may comprise a sufficient set of historical sequences (e.g., as defined by the performance of a predictive model 406a-c) to configure and/or train a predictive model 406a-c. In addition, or alternatively, a target data object 404 may correspond to a new target variable with a less than sufficient set of historical sequences (e.g., as defined by the performance of a predictive model 406a-c).

In some embodiments, the target data object 404 comprises a data structure that is associated with a new, unknown, and/or sparsely observed target variable. The target variable at the target data object 404 may change or update based on the characteristics of the target data object 404 over time. In an instance in which the target data object 404 is associated with a networked environment, the target data object 404 may be associated with interconnectivity properties which define how the target data object 404 and/or the target variable associated with the target data object 404 changes based on other interconnected data objects in the networked environment. As the target data object 404 is associated with a new, unknown, and/or sparsely observed target variable, the target data object 404 may be associated with a limited historical sequence of time-varying elements that may be insufficient to predict a future state of the target data object 404 and/or the target variable associated with the target data object 404. By way of example, in a network security domain, the target data object 404 may be associated with a newly detected computer virus with a limited footprint. As another example, in a clinical domain, the target data object may be associated with a newly diagnosed infectious disease, mental health issue, and/or the like.

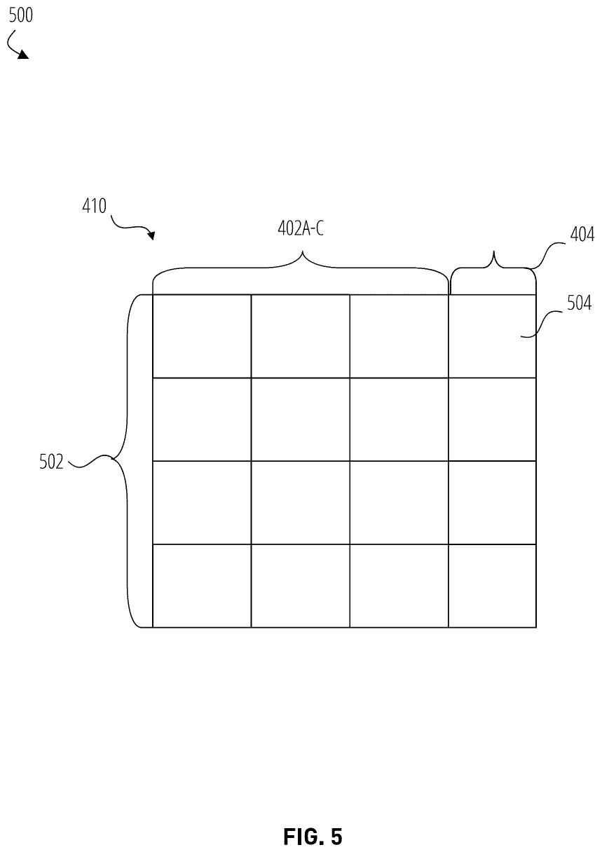

In some embodiments, the computing system 101 generates a feature matrix 410 for the set of data objects 408 based on up to each of a set of feature vectors. By way of example and as described in further detail with respect to FIG. 5, the feature matrix 410 may comprise a set of feature vectors respectively corresponding to the set of data objects 408 and arranged within a single data structure.

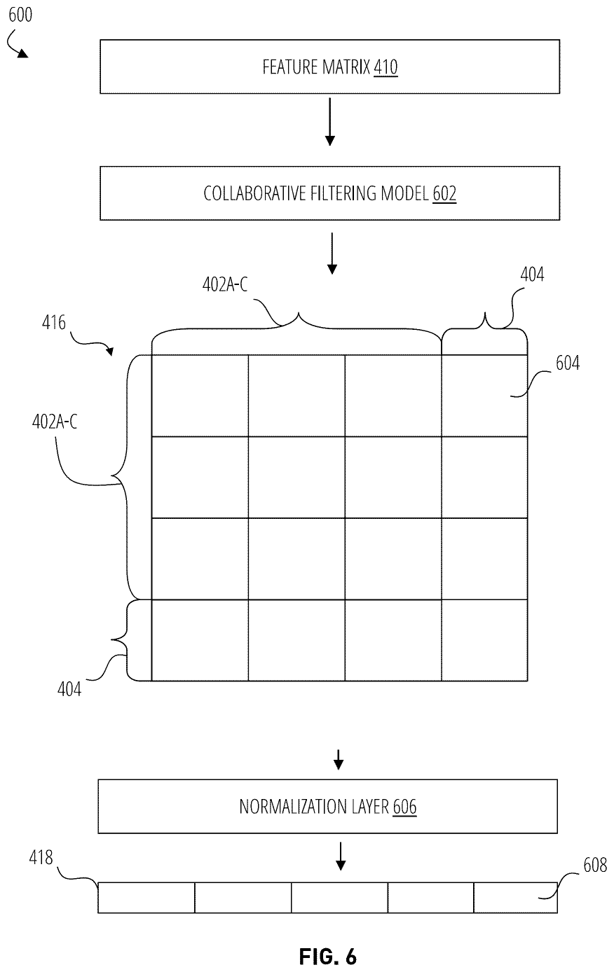

In some embodiments, the computing system 101 generates a similarity matrix 416 for the target data object 404 based on the feature matrix 410. By way of example and as described in further detail with respect to FIG. 6, the similarity matrix 416 may comprise a set of similarity quantifications that respectively correspond to the set of data objects 408 and the target data object 404. For instance, the set of similarity quantifications may comprise a similarity quantification for up to each pair of data objects within the set of data objects 408.

In some embodiments, the computing system 101 generates a set of model coefficients 418 by normalizing the similarity matrix 416 based on a normalization threshold. The model coefficients 418 may comprise any normalized value based on the similarity matrix 416 depicting a normalized similarity for a particular data object (e.g., set of data objects 408) to each of the other data objects. For example, a two-dimensional similarity matrix 416 may be normalized by ensuring the summation (e.g., normalization sum) of up to each of the similarity quantifications for a particular data object (e.g., in one row or one column) is equal to a normalization threshold.

For example, in one embodiment, all non-diagonal elements of the similarity matrix 416 in each column (n) may be normalized such that:

$${\sum }_{i = 1}^{i = N} {S}_{in} = {TH}_{n}$$

where N is the number of data objects (comprising the target data object) in the set of data objects 408; n is the column associated with the data object to be normalized; Sᵢₙ is the similarity quantification between data object i and data object j; and Thₙ is the normalization threshold.

In some embodiments, the model coefficients 418 for each row data object are determined by comparing the similarity quantification with a summation of all of the similarity quantifications in a column to determine a data object ratio. The data object ratio may then be applied to a normalization threshold to determine the model coefficient 418 for the row data object relative to the column data object.

The model coefficients 418 provide a similarity between two data objects, normalized with the other data objects in the set of data objects 408. By normalizing the similarity quantification across the set of data objects 408, the model coefficients 418 may be accurately compared, relative to the other data objects in the set of data objects 408.

In a disease progression use case, model coefficients 418 may be determined for each known disease (e.g., reference data objects 402a-c) relative to the unknown disease (e.g., target data object 404). Thus, the model coefficients 418 represent a normalized value indicating the proximity of the known disease to the unknown disease across the set of features comprised in the feature vector.

In a non-communicable disease use case, model coefficients 418 may be determined for each known cohort (e.g., reference data objects 402a-c) relative to the unknown cohort (e.g., target data object 404). Thus, the model coefficients 418 represent a normalized value indicating the proximity of the known cohort to the unknown cohort across the set of features comprised in the feature vector.

In a network security example, model coefficients may be determined for a set of known computer viruses, bugs, and/or the like (e.g., reference data objects 402a-c), relative to a new and unknown computer virus, bug, and/or the like (e.g., target data object 404). Thus, the modeled coefficients 418 represent a normalized value indicating the proximity of the known computer virus or bug to the unknown computer virus or bug across the set of features comprised in the feature vector.

In some embodiments, the computing system 101 generates, via the output transfer model 414, a transferred prediction 420 for the target data object 404 by applying the set of model coefficients 418 to a set of causal predictions that respectively correspond to the set of data objects 408. By way of example, the output transfer model 414 may generate a set of weighted causal predictions relative to the target data object 404. In some examples, a weighted causal prediction may be associated with a data object of the set of data objects 408 and may be based on a model coefficient 608 associated with the data object and a causal prediction associated with the data object. In some examples, the computing system 101, and/or the output transfer model 414 thereof, may generate the transferred prediction 420 based on an aggregation of the set of weighted causal predictions.

In some embodiments, a causal prediction of the set of causal predictions is based on a historical sequence of values that correspond to a particular data object. For example, a causal prediction of the set of causal predictions may be generated using a predictive model that is previously trained using training data that corresponds to a data object of the set of data objects 408. In some examples, the set of causal predictions may be respectively generated by a set of corresponding predictive models 406a-c that is respectively configured and/or trained for a subset of reference data objects 402a-c.

In some embodiments, the causal prediction comprises an output of a predictive model 406a-c indicating a predicted characteristic (e.g., target variable) of a data object (e.g., reference data object 402a-c) at a future timepoint. For example, a causal prediction may be a predicted value associated with a target variable of a reference data object 402a-c at a future timepoint. The causal prediction may be based on historical data, characteristics of the data object, interconnectivity of the data object with neighboring data objects, and/or machine learning models configured to model the behavior of a data object. In some embodiments, the causal prediction comprises a predicted characteristic based on an applied mitigating action. In such an instance, a single data object may have a plurality of causal predictions, wherein each causal prediction is associated with a mitigating action.

In some embodiments, a predictive model 406a-c is utilized to determine a set of causal predictions, wherein each causal prediction in the set of causal predictions represents the causal prediction for each data object in the set of reference data objects 402a-c. As such, the set of causal predictions may comprise a one-dimensional column of M causal predictions, each causal prediction associated with one of the M reference data objects in the set of data objects 408 (not comprising the target data object 404).

Further, in some embodiments, a predictive model 406a-c is utilized to determine a collection of sets of causal predictions, wherein each set of causal predictions in the collection of sets of causal predictions is associated with a different mitigating action. As such, the collection of sets of causal predictions may comprise P sets of causal predictions, wherein P is the number of mitigating actions for which a set of causal predictions is determined.

In the disease progression use case, the causal prediction may be a prediction rate of a transmittable disease at a particular geographic location at a future timepoint based on a particular mitigating action.

In the non-communicable disease use case, the causal prediction may be the predicted rate of symptoms associated with a non-communicable disease for a particular cohort based on a particular mitigating action.

In some embodiments, a predictive model 406a-c comprises a machine learning model that is configured to generate a time-based prediction based on a historical sequence and/or other predictive features (e.g., artificial intelligence). The machine learning model may comprise a graph-based model, such as a graph neural network (GNN), that is configured to generate a causal prediction. For example, the machine learning model may comprise a GNN with nodes and edges that model different attributes of a data object (e.g., reference data object 402a-c). By way of example, a node within a GNN may comprise a historical sequence and/or other attributes and may be connected via edges to related nodes with their own historical sequence and attributes. The GNN may be configured to generate a causal prediction for a particular node based on both the node attributes and the node's connection within the graph.

By way of example, one such predictive model 406a-c may comprise a connected model framework as described in U.S. patent application Ser. No. 18/980,308, which is incorporated by reference herein for all purposes. A connected model framework may comprise a causal directed acyclic graph and a machine learning network. The machine learning model is configured to model changes in the target variable for a particular data object over time. The causal prediction of the machine learning model may be adjusted based on one or more inputs from the causal directed acyclic graph. For example, in some embodiments, the causal directed acyclic graph models a mitigating action relative to the target variable of the data object. The causal directed acyclic graph generates one or more modification outputs to update the machine learning model based on the mitigating action associated with the causal directed acyclic graph. Thus, a collection of causal predictions may be generated for each reference data object 402a-c, for example, one causal prediction for each data object may be generated for each mitigating action in the set of mitigating actions.

In the disease progression use case, the connected model framework may be configured to generate a causal prediction related to the number of cases of a particular known disease in a geographic area at a future timepoint.

In the non-communicable disease use case, the connected model framework may be configured to generate a causal prediction related to a number of members of a known cohort exhibiting a particular symptom at a future timepoint.

In the network security example, the connected model framework may be configured to generate a causal prediction related to a number of systems infected with a known computer virus at a particular network location at future timepoint.

In some embodiments, the weighted causal prediction comprises the set of one or more causal predictions weighted based on the relative similarity of the reference data object 402a-c with a target data object 404. A weighted causal prediction may be determined by determining a causal prediction relative to a particular reference data object 402a-c and applying the model coefficient associated with the reference data object 402a-c to the causal prediction. By applying the model coefficient to the causal prediction, the causal prediction is effectively weighted based on the similarity of the reference data object 402a-c associated with the causal prediction with the target data object 404.

In some embodiments, the computing system implementing the similarity-based output transferring techniques determines a set of weighted causal predictions, wherein the set of weighted causal predictions is based on a set of causal predictions. As such, the set of weighted causal predictions may comprise a one-dimensional column of M weighted causal predictions, each weighted causal prediction associated with one of the M reference data objects 402a-c in the set of data objects 408 (not comprising the target data object 404).

Further, in some embodiments, the computing system determines a collection of sets of weighted causal predictions, wherein each set of weighted causal predictions in the collection of sets of weighted causal predictions is associated with a different mitigating action. As such, the collection of sets of weighted causal predictions may comprise P sets of weighted causal predictions, wherein P is the number of mitigating actions for which a set of causal predictions is determined.

In one non-limiting example, a first predictive model 406a associated with a first data object 402a may predict a target variable value of 100 at a future timepoint and the first data object 402a may be associated with a model coefficient 418 of 0.75 relative to the target data object 404. Thus, the weighted causal prediction may be set to (0.75)*100=75.

In some embodiments, the transferred prediction 420 comprises any prediction relative to a new or unknown target data object 404 without substantive historical data, wherein the prediction is determined based on causal predictions associated with a set of reference data objects 402a-c comprising historical data. A transferred prediction 420 may be determined by determining a similarity of the target data object 404 with each of the data objects in the set of reference data objects 402a-c. Causal predictions may be made for each reference data object 402a-c based on the characteristics of the data objects, comprising historical data and/or predicted effect of one or more mitigating actions. A transferred prediction 420 for the target data object 404 may be determined by weighting the causal predictions of the reference data objects 402a-c based on the similarity of the data object to the target data object 404 as indicated by the model coefficients 418.

In one example, suppose that the target data object 404 appears on column N of both the feature matrix 410 and the similarity matrix 416. Further, suppose the causal prediction for a particular data object is stored in a set of causal predictions at Ci where i is the reference data object 402a-c represented at row i of the set of causal predictions. The transferred prediction 420 for the target data object 404 may be determined by the equation:

$${C}_{N} = {\sum }_{i = 1}^{i = N - 1} {C}_{i} {S}_{i}$$

where Sᵢₙ is the similarity quantification between reference data object i and the target data object 404, and C_{N} is the transferred prediction 420 for the target data object 404 (N). Note that the above equation does not require causal estimates for reference data objects 402a-c that are fundamentally different from the target data object 404.

In some embodiments, a transferred prediction 420 is determined for each set of weighted causal predictions. Thus, the system may generate a collection of transferred predictions for the target data object 404, wherein each transferred prediction 420 in the collection of transferred predictions is associated with a different mitigating action.

In the disease progression use case, the transferred prediction 420 may be a predicted rate of a new or unknown disease at a particular geographic location based on the predicted transmission rates of one or more known diseases at the particular geographic location, and the similarity of each of the known diseases to the new or unknown disease.

In the non-communicable disease use case, the transferred prediction 420 may be the predicted rate of symptoms associated with a non-communicable disease.

In some embodiments, the computing system 101 initiates a performance of a prediction-based action based on the transferred prediction 420. In some examples, the transferred prediction 420 is one of a set of transferred predictions for the target data object 404 that respectively corresponds to a set of mitigating actions. The computing system 101 may determine, based on selection criteria, the transferred prediction 420 from the set of transferred predictions and, in response to the determination of the transferred prediction 420, the computing system 101 may initiate a performance of the mitigating action.

In some embodiments, the selection criteria comprises any criteria employed by the system to rank, sort, score, and/or otherwise analyze the transferred predictions 420 in the set of transferred predictions in order to determine an optimal transferred prediction. As described herein, the system may generate a set of transferred predictions each transferred prediction 420 based on a different mitigating action. The selection criteria may be utilized to select the optimal transferred prediction from the set of transferred predictions.

For example, the selection criteria may be based on the cost savings associated with each of the mitigating actions. The computing system implementing the herein described techniques may quantify the cost savings associated with the change in the target variable associated with the target data object 404. The computing system may then subtract the overall cost of implementing/executing the mitigating action and various derivative costs of the mitigating action. The computing system may then determine a cost savings by subtracting the overall cost of the mitigating action from the cost savings associated with the change in the target variable associated with the target data object 404.

The similarity-based output transferring techniques may consider implementation costs, operational costs, impact to a region or network location, and other impact associated with a mitigating action as selection criteria in determining the optimal transferred prediction. The selection criteria may further comprise overall reduction in the target variable, reduction in the target variable at a particular networked location, timeline to implement a mitigating action, relationship to other mitigating actions, and so on as selection criteria. In some embodiments, the system determines a score, rank, cost, or other metric associated with each transferred prediction based on the selection criteria and selects the optimal transferred prediction based on the determined score, rank, cost, or other metric. In some embodiments, a cost-benefit analysis is performed to determine the optimal transferred prediction.

In some embodiments, the prediction-based action comprises any action performed based on predictions derived from a transferred prediction 420. For example, a prediction-based action may comprise performing a mitigating action associated with the target data object 404. In some embodiments, the prediction-based action utilizes the selection criteria to determine an optimal transferred prediction 420 and perform the mitigating action based on the transferred prediction 420. For example, the system may apply selection criteria to each transferred prediction in the collection of transferred predictions. The system may then perform the mitigating action associated with the highest ranking/scoring transferred prediction 420.

In some embodiments, the mitigating action comprises any action intended to affect change to a target variable. For example, a mitigating action may be an action taken to reduce the target variable at a particular geographic location. In the disease progression use case, an example mitigating action to reduce an infection count in a particular geographic location may be to close an airport, for example. In the non-communicable disease use case, an example mitigating action may be a particular treatment tailored and deployed to resolve a particular symptom among a cohort of patients. In the network security use case, a mitigating action may comprise shutting down or disabling a particular networked location and/or specific resources at a networked location.

In some embodiments, the computing system 101 providing, based on the mitigating action associated with the transferred prediction 420, a control instruction to a networked location associated with the mitigating action to reduced movement within the networked location. In some examples, the networked location may be associated with a first historical sequence of values for a data object 402a of the set of data objects 408 that enables the configuration and/or training of a predictive model 406a corresponding to the data object 402a. In addition, or alternatively, the networked location may be associated with a second historical sequence of values for the target data object that is shorter than the first historical sequence of values and insufficient to configure and/or a train a predictive model for the target data object.

In some embodiments, the networked location comprises a geographic region, a computer, and/or any other physical or digital environment. By way of example, in a disease progression use case, the networked location may comprise a geographic region with a historical disease rate.

In some embodiments, the control instruction comprises any data construct transmittable by a system of the present disclosure to perform or cause the performance of a mitigating action. For example, a control instruction may be one or more messages transmitted across a network to a network location associated with the mitigating action. The control instructions may perform any action to cause the execution of the corresponding mitigating action. For example, a control instruction may shut down a system, send an alert, sound an alarm, notify personnel, provide instructions, recommend an action to be taken, and so on.

FIG. 5 is an operational example of an example feature matrix 410 in accordance with some embodiments of the present disclosure. As shown in the operational example 500, the feature matrix 410 may comprise a set of feature vectors 502 that may respectively correspond to a set of reference data objects 402a-c and/or the target data object 404. For instance, the feature matrix 410 may comprise a different feature vector 502 for up to each of the set of reference data objects 402a-c and/or the target data object 404. Each feature vector 502 comprises one or more feature values 504.

More particularly, in some embodiments, the feature matrix 410 comprises a data construct comprising a set of feature vectors 502 respectively associated with a set of reference data objects 402a-c. For example, the feature matrix 410 may comprise a feature vector 502 for up to each of the set of reference data objects 402a-c. In some examples, the feature matrix 410 may comprise at least a first feature vector associated with the target data object 404 and/or a subset of second feature vectors respectively corresponding to up to each of the set of reference data objects 402a-c. In some examples, up to each of the set of feature vectors 502 may define a set of feature values 504 for up to each of the same set of feature classes. In some examples, the feature matrix 410 may arrange the set of feature values 504 from up to each of the set of feature vectors 502 to align the feature values 504 of a particular feature class along a same horizontal and/or vertical plane. By doing so, the feature matrix 410 enables a one-to-one comparison of feature vectors 502 associated with different reference data objects 402a-c and the target data object 404.

In a network security use case, the feature vectors 502 may comprise feature values that identify a relative virality of a set of computer viruses, in the disease progression use case, the feature vectors 502 may comprise feature values that identify a relative transmissibility of a set of known and/or unknown transmittable diseases, in the non-communicable disease use case, the feature vectors 502 may comprise feature values that identify the features of cohort associated with the non-communicable disease.

The feature matrix 410 may comprise a two-dimensional array of data that defines a set of rows and a set of columns. In some examples, up to each of the set of columns corresponds to a data object and up to each of the set of rows corresponds to a specific feature class within the set of feature vectors 502 respectively corresponding to the set of data objects. For example, in a clinical use case, up to each of the set of columns may identify one of an existing and/or newly emergent disease and/or up to each of the set of row may identify one of a set of epidemiological features deemed pertinent to the transmission mechanisms and/or efficiency of the existing and/or newly emergent disease.

A feature vector 502 may comprises any data construct comprising a set, list, array, and/or collection of features of a data object. The feature vector 502, for example, may comprise a set of feature values 504 (e.g., numerical, categorical, probabilistic, binary) that identify any known characteristics of a data object deemed relevant to the target variable. For example, in a networked environment, the feature vector 502 may comprise movement characteristics of a target variable related to the movement of the target variable within and/or between networked locations of a networked environment. In the clinical use case, for example, a feature vector may comprise intrinsic transmission mechanisms and/or general contagiousness of an infectious disease, such as mode of transmission (e.g., airborne, sexually transmitted, water-born, animal, etc.), preferred temperature (e.g., 310 Kelvins-330 Kelvins, 300 Kelvins-310 Kelvins, 305 Kelvins-313 Kelvins, etc.), how the disease reproduces/survives (e.g., viral, bacteria, etc.), predominantly affected population (e.g., all, children, males, etc.), and/or the like. In addition, or alternatively, in a non-communicable disease use case, the feature vector may comprise demographics of a cohort (e.g., young urban single mothers who are economically deprived), health conditions of a cohort (e.g., obesity, rural deprivation, poor mental health), symptoms of a cohort, and/or the like. In some embodiments, the feature matrix 410 is designed by subject matter experts (e.g., expert epidemiologists) with an intimate knowledge of relevant features of the data objects.

FIG. 6 depicts a dataflow diagram 600 of an example output model instantiation technique in accordance with some embodiments of the present disclosure. As depicted, a computing system, such as the computing system 101, may implement the output model instantiation technique to convert a feature matrix 410 into a set of model coefficients 418. To do so, the computing system 101 may apply a collaborative filtering model 602 to the feature matrix 410 to convert the feature matrix 410 to a similarity matrix 416 with a set of unnormalized similarity quantifications 604 for up to each feature pair of the feature matrix 410. The computing system 101 may apply a normalization layer 606 to the similarity matrix 416 to convert the similarity quantifications 604 of the matrix into a set of model coefficients 418 that comprises a model coefficient 608 for up to each feature pair of the target data object 404. In this manner, the computing system 101 may convert a set of two-dimensional, derivative matrices into a set of light weight model coefficients 418 that may be encapsulated within an output transfer model 414. By doing so, the computing system 101 may generate a lightweight data structure (e.g., the output transfer model) capable of transferring machine learned outputs into transferred predictions for target data objects without the use of machine learning.

In some embodiments, the similarity matrix 416 comprises a similarity quantification 604 that identifies a degree of correspondence between two data objects, such as the target data object 404 and a reference data object, of the set of reference data objects 402a-c based on the feature matrix 410. In some examples, the similarity quantification 604 may be one of a set of similarity quantifications that correspond to up to each object pair within the set of data objects. In some examples, the similarity quantification 604 may comprise a value between zero and one.

The similarity matrix 416, for example, may comprise a data construct representing a comparison between up to each of a set of object pairs within the set of data objects. For example, the similarity matrix 416 may comprise a set of similarity quantifications 604 that each identify a similarity between two data objects within the set of data objects. A similarity quantification 604 may comprise any value, expression, and/or measurement representing a similarity between two data objects. The similarity quantification 604 may be determined by any means for comparing two data objects. For example, the similarity quantification 604 may be determined by any technique or algorithm configured to determine a distance between two feature vectors, such as a cosine similarity technique and/or other similar algorithm. In some embodiments, the similarity matrix 416 is determined by one or more subject matter experts, for example, the similarity of a reference data object 402a-c may be ranked and/or scored based on similarity to a target data object 404 by a subject matter expert analysis of the data objects. In some embodiments, the similarity matrix 416 is determined by a collaborative filtering model, as described as an example herein.

In some embodiments, the similarity matrix 416 comprises an N×N two-dimensional matrix, where N is the number of data objects in the set of data objects (e.g., comprising the set of reference data objects 402a-c and the target data object 404). In such an embodiment, each value i, j in the similarity matrix may represents a comparison (e.g., similarity quantification 604) of data object i with data object j, where i is the column index in the two-dimensional similarity matrix and j is the row index in the two-dimensional similarity index. In addition, or alternatively, a value of one may be specified when two data objects are the same (i=j), and/or zero may be specified when two data objects are fundamentally dissimilar. In some embodiments, the similarity quantification 604 comprises a value between 0 and 1 (i j).

In some embodiments, the similarity matrix 416 comprises a single column comprising a similarity quantification 604 of up to each reference data object 402a-c with the target data object 404. In such an embodiment, the column comprises a set of entries, one entry for each data object in the set of reference data objects 402a-c. Each entry comprises the similarity quantification 604 quantifying the similarity between the data object associated with the row in the similarity matrix 416 and the target data object 404. The similarity quantification 604 may comprise a number between 0 and 1. In some embodiments, a value of 1 is comprised in the column at the row associated with the target data object 404.

In clinical use case, a similarity matrix 416 may comprise a disease similarity matrix in which the similarity quantification at location i, j of the similarity matrix 416 may indicate the similarity of disease i with disease j. The disease similarity matrix is a square, symmetric matrix of size N×N, devised to describe how similar and/or dissimilar any two specific transmissible diseases are, as determined by the relevant disease columns in the feature matrix 410. For up to each pair of diseases, epidemiologists may define the relevant similarity quantification 604 based on the feature matrix 410. If the two diseases are fundamentally different from one another then the similarity quantification 604 may be set to zero. If the two diseases are the same (i=j), that is to say that a diagonal element of the similarity matrix 416 is being defined, then the similarity quantification 604 may be set to one. Additionally, or alternatively, other elements may be denoted by the similarity quantification 604 of the disease i with the disease j.

In the non-communicable disease use case, the similarity matrix 416 comprises a cohort similarity matrix in which the similarity quantification represents the similarity between two different cohorts. As still another example, in a network security use case, the similarity matrix 416 comprises a vulnerability similarity matrix in which the similarity quantification represents the similarity between two different computer vulnerabilities.

In some embodiments, the computing system 101 generates the similarity matrix 416 by applying a collaborative filtering model 602 to the feature matrix 410. The collaborative filtering model 602, for example, may comprise a collaborative filtering technique that leverages the idea that data objects that have similar characteristics are likely to exhibit similar characteristics in the future. A collaborative filtering model 602 may determine relationships between two items and determine a quantification of a similarity between the two items. In some embodiments, the collaborative filtering model 602 ranks, rates, and/or scores a set of reference data objects 402a-c based on similarity to a target data object 404. By identifying patterns in the data objects or relationships between the set of reference data objects 402a-c and the target data object 404, the collaborative filtering model 602 may accurately determine similarity quantifications 604 between a target data object 404 and each of the reference data objects 402a-c in the set of data objects. In some embodiments, the collaborative filtering model 602 comprises a recommender-based collaborative filtering model.

In some embodiments, the computing system 101, via the normalization layer 606, normalizes the similarity matrix 416 based on a normalization threshold to generate a set of model coefficients 418. In some examples, the normalization threshold may comprise a real number, such as two. Normalizing the similarity matrix 416 may comprises adjusting the similarity quantifications 604 of the similarity matrix 416 until an aggregate value of a set of similarity quantifications corresponding to a particular data object satisfies (e.g., equals) the normalization threshold (e.g., two).

In some embodiments, the normalization layer 606 comprises any model, mechanism, or technique configured to generate a set of normalized model coefficients 418 based on the similarity matrix 416. In some embodiments, a computing system 101 generates, via the normalization layer 606 a set of model coefficients 418 by applying a normalization technique to a particular data object, represented as a row or column in the similarity matrix 416. In one example embodiment, the normalization layer 606 determines a normalized model coefficient 608 based on each similarity quantification 604 in a row or column of the similarity matrix 416 such that the summation of all elements of the similarity matrix 416 in the row or column equal the normalized threshold (Thₙ) as shown below:

$${\sum }_{i = 1}^{i = N} {S}_{in} = {TH}_{n}$$

where N is the number of data objects (comprising the target data object 404) in the set of data objects; n is the column associated with the data object to be normalized; Sᵢₙ is the similarity quantification 604 between data object i and data object j; and Thₙ is the normalization threshold.

In some embodiments, the model coefficient 608 for a particular row data object is determined by comparing the similarity quantification 604 with a summation of all of the similarity quantifications 604 in a column to determine a data object ratio. The data object ratio may then be applied to a normalization threshold to determine the model coefficient 608 for the row data object relative to the column data object.

In some embodiments, the normalization threshold comprises a pre-determined value to which the model coefficients 418 associated with a particular data object sum up to. In some embodiments, the normalization threshold is set to an integer value (e.g., 1, 2, 100, 200, etc.).

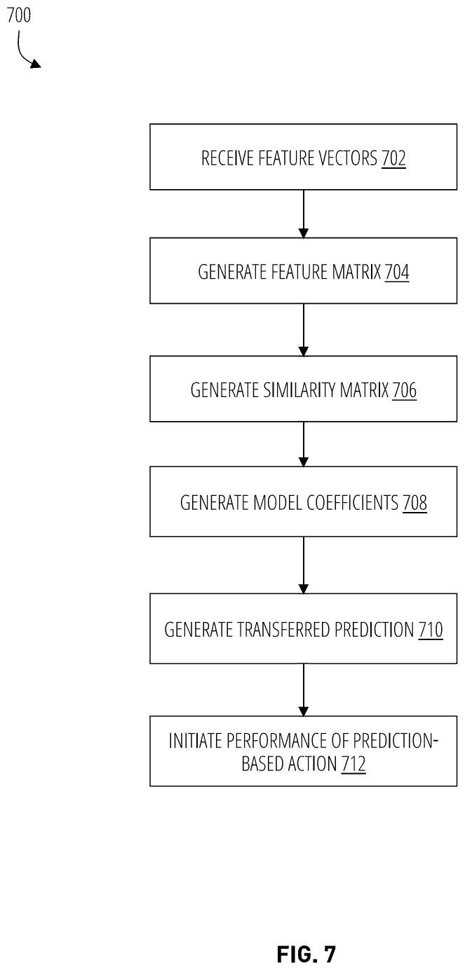

FIG. 7 is a flowchart diagram of an example output transferring process 700 in accordance with some embodiments of the present disclosure. The flowchart diagram depicts a similarity-based output transferring technique that learns an output transfer model capable to transforming machine learned outputs to related use cases. The process 700 may be implemented by one or more computing devices, entities, and/or systems described herein. For example, via the various steps/operations of the process 700, the computing system 101 may generate a series of derivative matrices and leverage the matrices a basis for initializing model coefficients of an output transfer model tailored to target data object that lacks a specializes machine learning model. By doing so, the process 700 improves computer functionality by extending the applicability of machine learning technology to nascent phenomena.

FIG. 7 illustrates an example process 700 for explanatory purposes. Although the example process 700 depicts a particular sequence of steps/operations, the sequence may be altered without departing from the scope of the present disclosure. For example, some of the steps/operations depicted may be performed in parallel or in a different sequence that does not materially impact the function of the process 700. In other examples, different components of an example device or system that implements the process 700 may perform functions at substantially the same time or in a specific sequence.

In some embodiments, the process 700 comprises, at operation 702, receiving feature vectors for up to each of a set of data objects and/or a target data object. For example, the computing system 101 may receive a feature vector for a target data object of a set of data objects.

In some embodiments, the process 700 comprises, at operation 704, generating a feature matrix based on the received feature vectors. For example, the computing system 101 may generate a feature matrix for the set of data objects based on the feature vector.

In some embodiments, the process 700 comprises, at operation 706, generating a similarity matrix based on the feature matrix. For example, the computing system 101 may generate a similarity matrix for the target data object based on the feature matrix. In some examples, the similarity matrix comprises a similarity quantification that identifies a degree of correspondence between the target data object and a data object of the set of data objects based on the feature matrix. In some examples, the similarity matrix may be generated by applying a collaborative filtering model to the feature matrix. In some examples, the similarity quantification is a value between zero and one. In some examples, the similarity quantification may be one of a set of similarity quantifications that correspond to a target data object.

In some embodiments, the process 700 comprises, at operation 708, generating a set of model coefficients from the similarity matrix. For example, the computing system 101 may generate a set of model coefficients by normalizing the similarity matrix 416 based on a normalization threshold. For example, the normalization threshold may be two, and normalizing the similarity matrix may comprise adjusting the similarity quantification until an aggregate value of the set of similarity quantifications equals two.

In some embodiments, the process 700 comprises, at operation 710, generating a transferred prediction for the target data object. For example, the computing system 101 may generate a transferred prediction for the target data object by applying the set of model coefficients to a set of causal predictions that respectively correspond to the set of data objects.

In some examples, a causal prediction of the set of causal predictions may be based on a historical sequence of values associated with a data object. For instance, a causal prediction of the set of causal predictions may be generated using a predictive model that is previously trained using training data that corresponds to a data object of the set of data objects. In some examples, the set of causal predictions may be respectively generated by a set of corresponding predictive models.

In some examples, the computing system 101 may generate a set of weighted causal predictions relative to the target data object 404. A weighted causal prediction may be associated with a data object of the set of data objects and/or may be based on a model coefficient associated with the data object and a causal prediction associated with the data object. The computing system 101 may generate the transferred prediction based on an aggregation of the set of weighted causal predictions.

In some embodiments, the process 700 comprises, at operation 712, initiating a performance of a prediction-based action based on the transferred prediction. For example, the computing system 101 may initiate a performance of a prediction-based action based on the transferred prediction. In some examples, the transferred prediction is one of a set of transferred predictions for the target data object that respectively corresponds to a set of mitigating actions. The computing system 101 may determine, based on selection criteria, the transferred prediction from the set of transferred predictions and, in response to the determination of the transferred prediction, the computing system 101 may initiate a performance of the mitigation action. For example, the computing system 101 may provide, based on the mitigating action associated with the transferred prediction, a control instruction to a networked location associated with the mitigating action to reduced movement within the networked location. In some examples, the networked location is associated with a first historical sequence of values for a data object of the set of data objects and a second historical sequence of values for the target data object that is shorter than the first historical sequence of values.

Some techniques of the present disclosure enable the generation of action outputs that may be performed to initiate one or more real world actions to achieve real-world effects. The techniques of the present disclosure may be used, applied, and/or otherwise leveraged to transmit one or more control instructions to perform or cause the performance of a mitigating action relative to a target data object. In some examples, the transferred predictions of the present disclosure may trigger action outputs (e.g., through control instructions) to automate controlling a hardware component, providing alerts, initiating interactive actions, and/or the like. The action outputs may control various aspects of a client device, such as the display, transmission, and/or the like of data reflective of an alert, and/or the like. The alert may be automatically communicated to a user and/or may be used to initiate a shut down of a hardware component or physical location, initiate a security protocol (e.g., locking a computer or system), update one or more security settings, and/or the like.

In some examples, the computing tasks may comprise actions that may be based on a particular domain. A domain may comprise any environment in which computing systems may be applied to interpret, store, and process data and initiate the performance of computing tasks responsive to the data. These actions may cause real-world changes, for example, by controlling a hardware component, providing alerts, interactive actions, and/or the like. For instance, actions may comprise the initiation of automated instructions across and between devices, automated notifications, automated scheduling operations, automated precautionary actions, automated security actions, automated data processing actions, and/or the like.

### IV. CONCLUSION

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as comprising logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components comprise a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components may provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and may operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that may be implemented in hardware, software, or a combination thereof. In the context of software, the operations represent computer-executable instructions stored on one or more computer-readable storage media that, when executed by one or more processors, perform the recited operations. Generally, computer-executable instructions comprise routines, programs, objects, components, data structures, and the like that perform particular functions or implement particular data types. The order in which the operations are described is not intended to be construed as a limitation, and any number of the described operations may be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These comprise physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is comprised in at least one embodiment, but not every embodiment necessarily comprises the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “comprises,” “including,” “has,” “having” or any other variation thereof, are intended to cover a non-exclusive inclusion. For example, a process, method, article, or apparatus that comprises a list of elements is not necessarily limited to only those elements but may comprise other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and may be a null set (i.e., a set containing zero elements) or may comprise one, two, or more elements. A “subset” is intended to mean a collection of elements that are all elements of a set, but that does not comprise other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” may be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations may encompass implementations in which performance of the operations is divided among the processor(s) in any suitable way. For example, “generating, by one or more processors, X; and generating, by the one or more processors, Y” may encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may comprise a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters (e.g., for unsupervised machine-learned models).

In some examples, structural hyperparameter(s) may define component(s) of the model's architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may comprise a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may comprise any type of model configured, trained, and/or the like to generate a prediction output for a model input. In some examples, any of the logic, component(s), routines, and/or the like discussed herein may be implemented as a machine-learned model.

The machine-learned model may comprise one or more of any type of machine-learned model including one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

### V. EXAMPLES

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may comprise a single computing entity that is configured to perform the steps/operations of a particular example. In addition, or alternatively, a computing system may comprise multiple dedicated computing entities that are respectively configured to perform one or more of the steps/operations of a particular example. By way of example, the multiple dedicated computing entities may coordinate to perform the steps/operations of a particular example.

Example 1. A computer-implemented method comprising: receiving, by one or more processors, a feature vector for a target data object of a set of data objects; generating, by the one or more processors, a feature matrix for the set of data objects based on the feature vector; generating, by the one or more processors, a similarity matrix for the target data object based on the feature matrix; generating, by the one or more processors, a set of model coefficients by normalizing the similarity matrix based on a normalization threshold; generating, by the one or more processors, a transferred prediction for the target data object by applying the set of model coefficients to a set of causal predictions that respectively correspond to the set of data objects; and initiating, by the one or more processors, a performance of a prediction-based action based on the transferred prediction.

Example 2. The computer-implemented method of example 1, wherein the similarity matrix comprises a similarity quantification that identifies a degree of correspondence between the target data object and a data object of the set of data objects based on the feature matrix.

Example 3. The computer-implemented method of example 2, wherein the similarity matrix is generated by applying a collaborative filtering model to the feature matrix.

Example 4. The computer-implemented method of any of the preceding examples, wherein (i) the similarity quantification (a) is a value between zero and one and (b) is one of a set of similarity quantifications that correspond to the target data object, (ii) the normalization threshold is two, and (iii) normalizing the similarity matrix comprises adjusting the similarity quantification until an aggregate value of the set of similarity quantifications equals two.

Example 5. The computer-implemented method of any of the preceding examples, wherein generating the transferred prediction further comprises: generating a set of weighted causal predictions relative to the target data object, wherein a weighted causal prediction is associated with a data object of the set of data objects, and is based on a model coefficient associated with the data object and a causal prediction associated with the data object; and generating the transferred prediction based on an aggregation of the set of weighted causal predictions.

Example 6. The computer-implemented method of any of the preceding examples, wherein the transferred prediction is one of a set of transferred predictions for the target data object that respectively corresponds to a set of mitigating actions and initiating the performance of the prediction-based action based on the transferred prediction comprises: determining, based on selection criteria, the transferred prediction from the set of transferred predictions; and in response to determining the transferred prediction, initiating a performance of a mitigating action corresponding to the transferred prediction.

Example 7. The computer-implemented method of example 6, wherein initiating the performance of the prediction-based action further comprises providing, based on the mitigating action associated with the transferred prediction, a control instruction to a networked location associated with the mitigating action to reduce movement within the networked location.

Example 8. The computer-implemented method of example 7, wherein the networked location is associated with a first historical sequence of values for a data object of the set of data objects and a second historical sequence of values for the target data object that is shorter than the first historical sequence of values.

Example 9. The computer-implemented method of example 8, wherein a causal prediction of the set of causal predictions that corresponds to the data object is based on the first historical sequence of values.

Example 10. The computer-implemented method of any of the preceding examples, wherein a causal prediction of the set of causal predictions is generated using a predictive model that is previously trained using training data that corresponds to a data object of the set of data objects.

Example 11. The computer-implemented method of any of the preceding examples, wherein the set of causal predictions is respectively generated by a set of corresponding predictive models.

Example 12. A system comprising: one or more processors; and one or more memories storing processor-executable instructions that, when executed by the one or more processors, cause the one or more processors to perform operations comprising: receiving, by the one or more processors, a feature vector for a target data object of a set of data objects; generating, by the one or more processors, a feature matrix for the set of data objects based on the feature vector; generating, by the one or more processors, a similarity matrix for the target data object based on the feature matrix; generating, by the one or more processors, a set of model coefficients by normalizing the similarity matrix based on a normalization threshold; generating, by the one or more processors, a transferred prediction for the target data object by applying the set of model coefficients to a set of causal predictions that respectively correspond to the set of data objects; and initiating, by the one or more processors, a performance of a prediction-based action based on the transferred prediction.

Example 13. The system of example 12, wherein the similarity matrix comprises a similarity quantification that identifies a degree of correspondence between the target data object and a data object of the set of data objects based on the feature matrix.

Example 14. The system of example 13, wherein the similarity matrix is generated by applying a collaborative filtering model to the feature matrix.

Example 15. The system of any of examples 12 to 14, wherein (i) the similarity quantification (a) is a value between zero and one and (b) is one of a set of similarity quantifications that correspond to the target data object, (ii) the normalization threshold is two, and (iii) normalizing the similarity matrix comprises adjusting the similarity quantification until an aggregate value of the set of similarity quantifications equals two.

Example 16. The system of any of examples 12 to 15, wherein generating the transferred prediction further comprises: generating a set of weighted causal predictions relative to the target data object, wherein a weighted causal prediction is associated with a data object of the set of data objects, and is based on a model coefficient associated with the data object and a causal prediction associated with the data object; and generating the transferred prediction based on an aggregation of the set of weighted causal predictions.

Example 17. The system of any of example 12 to 16, wherein the transferred prediction is one of a set of transferred predictions for the target data object that respectively corresponds to a set of mitigating actions and initiating the performance of the prediction-based action based on the transferred prediction comprises: determining, based on selection criteria, the transferred prediction from the set of transferred predictions; and in response to determining the transferred prediction, initiating a performance of a mitigating action corresponding to the transferred prediction.

Example 18. The system of example 17, wherein initiating the performance of the prediction-based action further comprises providing, based on the mitigating action associated with the transferred prediction, a control instruction to a networked location associated with the mitigating action to reduced movement within the networked location.

Example 19. The system of example 18, wherein the networked location is associated with a first historical sequence of values for a data object of the set of data objects and a second historical sequence of values for the target data object that is shorter than the first historical sequence of values.

Example 20. One or more non-transitory computer-readable media storing processor-executable instructions that, when executed by one or more processors, cause the one or more processors to perform operations comprising: receiving, by the one or more processors, a feature vector for a target data object of a set of data objects; generating, by the one or more processors, a feature matrix for the set of data objects based on the feature vector; generating, by the one or more processors, a similarity matrix for the target data object based on the feature matrix; generating, by the one or more processors, a set of model coefficients by normalizing the similarity matrix based on a normalization threshold; generating, by the one or more processors, a transferred prediction for the target data object by applying the set of model coefficients to a set of causal predictions that respectively correspond to the set of data objects; and initiating, by the one or more processors, a performance of a prediction-based action based on the transferred prediction.

What is claimed is:

1. A computer-implemented method comprising:
receiving, by one or more processors, a feature vector for a target data object of a set of data objects;
generating, by the one or more processors, a feature matrix for the set of data objects based on the feature vector;
generating, by the one or more processors, a similarity matrix for the target data object based on the feature matrix;
generating, by the one or more processors, a set of model coefficients by normalizing the similarity matrix based on a normalization threshold;
generating, by the one or more processors, a transferred prediction for the target data object by applying the set of model coefficients to a set of causal predictions that respectively correspond to the set of data objects; and
initiating, by the one or more processors, a performance of a prediction-based action based on the transferred prediction.

2. The computer-implemented method of claim 1, wherein the similarity matrix comprises a similarity quantification that identifies a degree of correspondence between the target data object and a data object of the set of data objects based on the feature matrix.

3. The computer-implemented method of claim 2, wherein the similarity matrix is generated by applying a collaborative filtering model to the feature matrix.

4. The computer-implemented method of claim 2, wherein (i) the similarity quantification (a) is a value between zero and one and (b) is one of a set of similarity quantifications that correspond to the target data object, (ii) the normalization threshold is two, and (iii) normalizing the similarity matrix comprises adjusting the similarity quantification until an aggregate value of the set of similarity quantifications equals two.

5. The computer-implemented method of claim 1, wherein generating the transferred prediction further comprises:
generating a set of weighted causal predictions relative to the target data object, wherein a weighted causal prediction is associated with a data object of the set of data objects, and is based on a model coefficient associated with the data object and a causal prediction associated with the data object; and
generating the transferred prediction based on an aggregation of the set of weighted causal predictions.

6. The computer-implemented method of claim 1, wherein the transferred prediction is one of a set of transferred predictions for the target data object that respectively corresponds to a set of mitigating actions and initiating the performance of the prediction-based action based on the transferred prediction comprises:
determining, based on selection criteria, the transferred prediction from the set of transferred predictions; and
in response to determining the transferred prediction, initiating a performance of a mitigating action corresponding to the transferred prediction.

7. The computer-implemented method of claim 6, wherein initiating the performance of the prediction-based action further comprises providing, based on the mitigating action associated with the transferred prediction, a control instruction to a networked location associated with the mitigating action to reduce movement within the networked location.

8. The computer-implemented method of claim 7, wherein the networked location is associated with a first historical sequence of values for a data object of the set of data objects and a second historical sequence of values for the target data object that is shorter than the first historical sequence of values.

9. The computer-implemented method of claim 8, wherein a causal prediction of the set of causal predictions that corresponds to the data object is based on the first historical sequence of values.

10. The computer-implemented method of claim 1, wherein a causal prediction of the set of causal predictions is generated using a predictive model that is previously trained using training data that corresponds to a data object of the set of data objects.

11. The computer-implemented method of claim 1, wherein the set of causal predictions is respectively generated by a set of corresponding predictive models.

12. A system comprising:
one or more processors; and
one or more memories storing processor-executable instructions that, when executed by the one or more processors, cause the one or more processors to perform operations comprising:
receiving, by the one or more processors, a feature vector for a target data object of a set of data objects;
generating, by the one or more processors, a feature matrix for the set of data objects based on the feature vector;
generating, by the one or more processors, a similarity matrix for the target data object based on the feature matrix;
generating, by the one or more processors, a set of model coefficients by normalizing the similarity matrix based on a normalization threshold;
generating, by the one or more processors, a transferred prediction for the target data object by applying the set of model coefficients to a set of causal predictions that respectively correspond to the set of data objects; and
initiating, by the one or more processors, a performance of a prediction-based action based on the transferred prediction.

13. The system of claim 12, wherein the similarity matrix comprises a similarity quantification that identifies a degree of correspondence between the target data object and a data object of the set of data objects based on the feature matrix.

14. The system of claim 13, wherein the similarity matrix is generated by applying a collaborative filtering model to the feature matrix.

15. The system of claim 13, wherein (i) the similarity quantification (a) is a value between zero and one and (b) is one of a set of similarity quantifications that correspond to the target data object, (ii) the normalization threshold is two, and (iii) normalizing the similarity matrix comprises adjusting the similarity quantification until an aggregate value of the set of similarity quantifications equals two.

16. The system of claim 12, wherein generating the transferred prediction further comprises:
generating a set of weighted causal predictions relative to the target data object, wherein a weighted causal prediction is associated with a data object of the set of data objects, and is based on a model coefficient associated with the data object and a causal prediction associated with the data object; and
generating the transferred prediction based on an aggregation of the set of weighted causal predictions.

17. The system of claim 12, wherein the transferred prediction is one of a set of transferred predictions for the target data object that respectively corresponds to a set of mitigating actions and initiating the performance of the prediction-based action based on the transferred prediction comprises:
determining, based on selection criteria, the transferred prediction from the set of transferred predictions; and
in response to determining the transferred prediction, initiating a performance of a mitigating action corresponding to the transferred prediction.

18. The system of claim 17, wherein initiating the performance of the prediction-based action further comprises providing, based on the mitigating action associated with the transferred prediction, a control instruction to a networked location associated with the mitigating action to reduced movement within the networked location.

19. The system of claim 18, wherein the networked location is associated with a first historical sequence of values for a data object of the set of data objects and a second historical sequence of values for the target data object that is shorter than the first historical sequence of values.

20. One or more non-transitory computer-readable media storing processor-executable instructions that, when executed by one or more processors, cause the one or more processors to perform operations comprising:
receiving, by the one or more processors, a feature vector for a target data object of a set of data objects;
generating, by the one or more processors, a feature matrix for the set of data objects based on the feature vector;
generating, by the one or more processors, a similarity matrix for the target data object based on the feature matrix;
generating, by the one or more processors, a set of model coefficients by normalizing the similarity matrix based on a normalization threshold;
generating, by the one or more processors, a transferred prediction for the target data object by applying the set of model coefficients to a set of causal predictions that respectively correspond to the set of data objects; and
initiating, by the one or more processors, a performance of a prediction-based action based on the transferred prediction.
